(19) United States
(12) Patent Application Publication
(10) Pub. No.: US 2024/0329011 A1
(43) Pub. Date: Oct. 3, 2024

(54) COMPUTATIONS TRAINED MACHINE LEARNING MODELS FOR NON-DESTRUCTIVE EVALUATION OF MATERIAL AND STRUCTURAL FLAWS

(71) Applicant: BROWN UNIVERSITY, Providence, RI (US)

(72) Inventors: Vikas Srivastava, Providence, RI (US); Sijun Niu, Providence, RI (US)

(21) Appl. No.: 18/711,899

(22) PCT Filed: Dec. 1, 2022
(86) PCT No.: PCT/US2022/051529

§ 371 Date: May 21, 2024

Related U.S. Application Data
(60) Provisional application No. 63/284,660, filed on Dec. 1, 2021.

(51) Int. Cl. G01N 29/44; G01N 29/06; G06N 3/08

(52) U.S. Cl. CPC G01N 29/4472; G01N 29/0609; G01N 29/4481; G06N 3/08; G01N 2291/04

(57) ABSTRACT

Systems and methods for training a machine learning model for non-destructive evaluation. A plurality of training samples are generated, with a subset of the plurality of training samples representing an article with a defect or a combination of defects. Training samples are generated by generating a virtual model of the article with defect at a computer system, generating a simulated signal representing an output of a non-destructive evaluation system scanning the physical article using the virtual model at the computer system, and associating a representation of the simulated signal with parameters representing a characteristic of the virtual model of the article with defects. The machine learning model is trained on the plurality of training samples. The trained machine learning model is applied on to measurements collected from physical articles to characterize or quantify defects.

### RELATED APPLICATIONS

This application claims priority from U.S. Provisional Patent Application Ser. No. 63/284,660 filed on Dec. 1, 2021 and entitled “Computational Simulations Trained Neural Network to Characterize Non-Visible Material Flaws from Ultrasound Real-Life Measurements,” which is hereby incorporated by reference in its entirety.

### TECHNICAL FIELD

The present invention relates to the non-destructive evaluation of materials for defects, and more particularly, to training machine learning models using computer simulations for non-destructive evaluation.

### BACKGROUND

Embedded non-visible flaws can exist in load bearing structures. These flaws form during material forming operations or while in service through processes such as chemical reactions, excessive loading, fatigue, and thermal cycles. The existence of cracks and crack-like flaws can significantly threaten structural integrity as the growth and sudden propagation of a crack can lead to catastrophic failure of the structure. Detection of embedded non-visible cracks and accurate prediction of their length, location, and orientation is critical to assess fitness for service of a structure.

Ultrasound tests (UT) due to ease of use, speed, and cost-efficiency, are one of the primary nondestructive evaluation (NDE) methods for detecting crack-like flaws during the material fabrication stage or during in-the-field operations for load bearing structures. The key component of an ultrasound unit is a piezoelectric element that converts an electrical signal to mechanical vibration and vice versa. The pulse-echo technique is a common ultrasonic flaw detection approach, in which the wave generated by the piezoelectric element reflects from flaws and interfaces and is recorded as echoes or peaks in a scan. An A-scan is a time-amplitude interpretation of received ultrasound signal and contains information about existing flaws. However, detecting flaws such as corrosion and/or cracks and predicting critical properties like length, location, and orientation of crack-like flaws from an ultrasonic scan has been a major challenge.

### SUMMARY OF THE INVENTION

In one aspect of the present invention, a method is provided for training a machine learning model for non-destructive evaluation. A plurality of training samples are generated, with a subset of the plurality of training samples representing an article with a defect. Training samples are generated by creating a virtual model of the article at a computer system, generating a simulated signal representing an output of a non-destructive evaluation system scanning the article based on the virtual model at the computer system, and associating a representation of the simulated signal with a parameter representing a characteristic of the virtual model of the article. The machine learning model is trained on the plurality of training samples.

In another aspect of the present invention, a system includes a processor and a non-transitory computer readable medium storing instructions for training a machine learning model for non-destructive testing. The instructions are executable by the processor to provide a sample generation system that generates a plurality of training samples. Each of a subset of the plurality of training samples represents an article with a defect. The sample generation system includes a computational modeling component that generates a virtual model of a given article and generates a simulated signal representing an output of a non-destructive evaluation system scanning the physical real-life article through the virtual computational model. A sample labeler associates a representation of the simulated signal with a parameter or a set of parameters representing a characteristic of the virtual model of the given article to generate the given training sample. A training component trains the machine learning model on the plurality of training samples to produce a trained machine learning model.

In a further aspect of the present invention, a method is provided for training a convolutional neural network for non-destructive evaluation. A plurality of training samples are generated, with a subset of the plurality of training samples representing an article with a defect or more than one defect. Training samples are generated by generating a virtual model of the article in a computer system, generating a simulated ultrasound signal representing an output of an ultrasound system scanning the physical real-life article through the virtual model at the computer system, and associating the simulated ultrasound signal with a parameter representing a characteristic of the virtual model of the article. The convolutional neural network is trained on the plurality of training samples.

### BRIEF DESCRIPTION OF THE DRAWINGS

FIG. 1 illustrates a system for training a machine learning model for use in non-destructive testing of physical articles;

FIG. 2 illustrates another example of a system for training a machine learning model using a computer-generated virtual model;

FIG. 3 illustrates another example of a system for training a machine learning model using a computer-generated virtual model;

FIG. 4 illustrates one example of a method for training a machine learning model for non-destructive evaluation;

FIG. 5 illustrates a method for non-destructive testing of an article;

FIG. 6 illustrates another example of a method for training a convolutional neural network for non-destructive evaluation; and

FIG. 7 is a schematic block diagram illustrating an exemplary system of hardware components capable of implementing examples of the systems and methods disclosed in FIGS. 1-6.

### DETAILED DESCRIPTION

As used herein, a “categorical value” is a value that can be represented by one of a number of discrete possibilities, which may or may not have a meaningful ordinal ranking. A “continuous value,” as used herein, is a value that can take on any of a number of numerical values within a range. It will be appreciated that, in a practical application, values are expressed in a finite number of significant digits, and thus a “continuous value” can be limited to a number of discrete values within the range.

As used herein, data is provided from a first system to a second system when it is either provided directly from the first system to the second system, for example, via a local bus connection, or stored in a local or remote non-transitory memory by the first system for later retrieval by the second system. Accordingly in some implementations, the first system and the second system can be located remotely and in communication only through an intermediate medium connected to at least one of the systems by a network connection.

A “computational modeling system” or “computational modeling component” is a system that allows for the geometry, material properties, and mechanical response of physical articles to be represented as a virtual model. One example of a computational modeling system is a finite element modeling system.

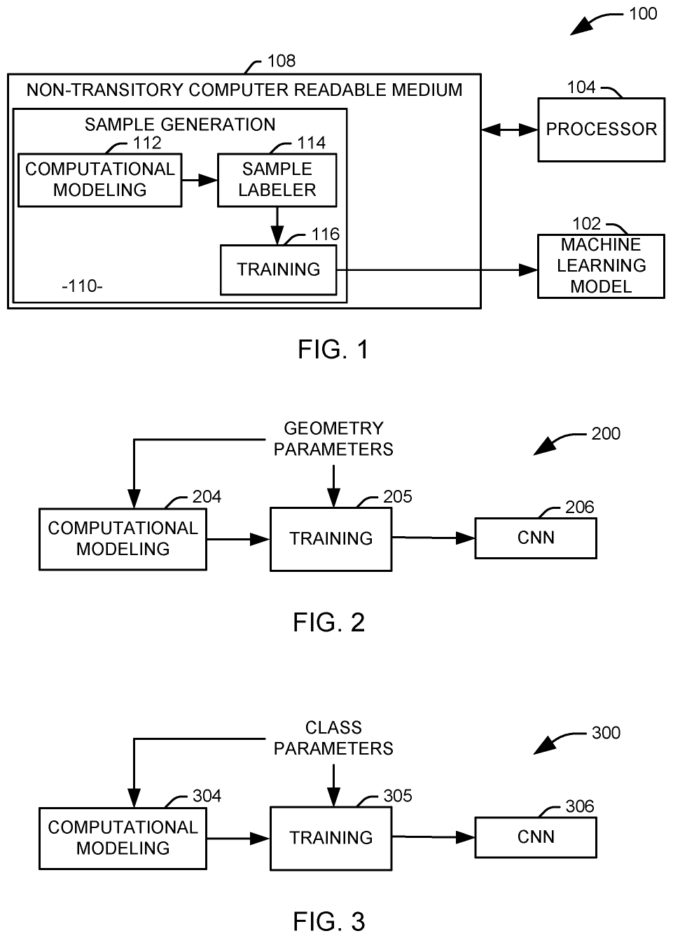

FIG. 1 illustrates a system 100 for training a machine learning model 102 for use in non-destructive testing of physical articles. In particular, the system 100 uses finite element modeling to generate virtual returns for a non-destructing testing system, such as an ultrasound imager, on a virtual model of the article having known characteristics and trains the machine learning model using the virtual returns and the known characteristics. In the illustrated example, the system 100 includes a processor 104 and a non-transitory computer readable medium 108 storing instructions for training the machine learning model 102. The instructions are executable by the processor 104 to provide a sample generation system 110 that generates a plurality of training samples. At least a subset of the plurality of training samples will represent an article with a defect, and in some implementations, the subset will be a proper subset such that all of the training samples will represent an article having a defect.

The sample generation system 110 includes computational modeling component 112 that generates a virtual model of a given article and generates a simulated signal representing an output of a non-destructive evaluation system scanning the physical article based on the virtual model. In one example, the computational modelling component 112 generates a simulated ultrasound signal representing an output of an ultrasound system scanning the article as a time series of values. In practice, the computational modeling component 112 can be configured to generate virtual models of articles having various types of flaws with varying geometries. In one implementation, the computational modeling component 112 can generate virtual models of articles having one or both cracks having selectable lengths, orientations, and locations, as well as patches of corrosion with selectable width, height, and corrosion. The virtual models can be configured with varying material properties to represent articles formed from various materials, including both metallic articles and non-metallic articles, such as articles formed from polymers. To conserve processing resources, the resolution of the virtual models can vary, with smaller elements used near the location of the defect, and larger elements used in locations farther from the defect.

A sample labeler 114 associates a representation of the simulated signal with a parameter representing a characteristic of the virtual model of the given article to generate the given training sample. In one implementation, the representation of the simulated signal is a set of numerical features representing the sample. For example, a discrete wavelet transform can be applied to the simulated signal and one or more coefficients associated with the wavelet transform can be used as features for the machine learning model 102. In another implementation, the simulated signal itself, represented as a time series of digital samples, can be provided to the machine learning model 102 as an input. In practice, this approach can be used with deep learning models, such as convolutional neural networks and recurrent neural networks. It will be appreciated that the simulated signal can be provided to the machine learning model 102 in raw form or after some preprocessing, including a normalization of the values within the time series to a standard scale of values.

The parameter representing the characteristic of the virtual model of the given article can vary with the implementation. In one example, the parameter can be a categorical parameter representing one or more of the presence or absence of a defect, a type of defect, or ranges of values representing the geometry of the defect. In one example, the parameter represents one of a plurality of classes, including a first class representing an absence of a defect in the virtual model of the article, a second class representing the presence of a first type of defect in the virtual model of the article, a third class representing a second type of defect in the virtual model of the article, and a fourth class representing multiple defects in the virtual model of the article. In another example, the parameter is a continuous parameter representing a geometry of a defect, such as a length, width, orientation, or location of the defect, or a likelihood of the presence or absence of a defect generally or of a specific type of defect. In one example, three parameters are assigned to each training sample, with a first parameter representing a length of a crack in the virtual model of the article, a second parameter representing the orientation of the crack in the virtual model of the article, and a third parameter representing a location of the crack in the virtual model of the article.

A training component 116 trains the machine learning model 102 on the plurality of training samples to produce a trained machine learning model. In one implementation, once the training is complete, the machine learning model 102 is implemented as an integrated circuit chip onboard a non-destructive evaluation system. The training process of the machine learning model 102 will vary with its implementation, but training generally involves a statistical aggregation of training data into one or more model parameters that define the model. In general, some form of the optimization process is applied to fit the model parameters to the training data. For rule-based models, such as decision trees, domain knowledge, for example, as provided by one or more human experts, can be used in place of or to supplement training data in selecting rules for classifying a user using the input data. Any of a variety of techniques can be utilized for the models, including support vector machines, regression models, self-organized maps, k-nearest neighbor classification or regression, fuzzy logic systems, data fusion processes, boosting and bagging methods, rule-based systems, or neural networks.

The machine learning model 102 can utilize one or more pattern recognition algorithms, each of which receive a signal from a non-destructive testing system and generate a parameter representing the scanned article. Where multiple classification or regression models are used, an arbitration element can be utilized to provide a coherent result from the plurality of models. Further, the models can be sequential, with a first model determining if a defect is present or if a particular type of defect is present, and a second model determining one or more parameters representing the geometry of the defect.

A support vector machine (SVM) can utilize a plurality of functions, referred to as hyperplanes, to conceptually divide boundaries in the N-dimensional feature space, where each of the N dimensions represents one associated feature of the feature vector. The boundaries define a range of feature values associated with each class. Accordingly, an output class and an associated confidence value can be determined for a given input feature vector according to its position in feature space relative to the boundaries. In one implementation, the SVM can be implemented via a kernel method using a linear or non-linear kernel.

An artificial neural network (ANN) classifier comprises a plurality of nodes having a plurality of interconnections. The values from the feature vector are provided to a plurality of input nodes. The input nodes each provide these input values to layers of one or more intermediate nodes. A given intermediate node receives one or more output values from previous nodes. The received values are weighted according to a series of weights established during the training of the classifier. An intermediate node translates its received values into a single output according to a transfer function at the node. For example, the intermediate node can sum the received values and subject the sum to a binary step function. A final layer of nodes provides the confidence values for the output classes of the ANN, with each node having an associated value representing a confidence for one of the associated output classes of the classifier.

A convolutional neural network can be used. A Convolutional neural network includes convolutional layers in which nodes from a previous layer are only connected to a subset of the nodes in the convolutional layer. In one example, the machine learning model 102 is a convolutional neural network having a plurality of convolutional layers, a pooling layer, and a plurality of fully connected layers. In this example, the training component 116 provides a set of sample values representing the simulated signal directly to a first convolutional layer of the plurality of convolutional layers.

A rule-based classifier applies a set of logical rules to the extracted features to select an output class where a feature extraction process is selected. Generally, the rules are applied in order, with the logical result at each step influencing the analysis at later steps. The specific rules and their sequence can be determined from any or all of training data, analogical reasoning from previous cases, or existing domain knowledge. One example of a rule-based classifier is a decision tree algorithm, in which the values of features in a feature set are compared to corresponding threshold in a hierarchical tree structure to select a class for the feature vector. A random forest classifier is a modification of the decision tree algorithm using a bootstrap aggregating, or “bagging” approach. In this approach, multiple decision trees are trained on random samples of the training set, and an average (e.g., mean, median, or mode) result across the plurality of decision trees is returned. For a classification task, the result from each tree would be categorical, and thus a modal outcome can be used.

FIG. 2 illustrates another example of a system 200 for training a machine learning model using a computer-generated virtual model. In this example finite element simulations were conducted at a computational modeling component 204 to generate signals representing ultrasound non-destructive testing A-scans and these signals are used at a training component 205 to train a convolutional neural network (CNN) 206 to predict length, location, and orientation of embedded cracks. In the illustrated implementation, the cracks are generated in the 1-3 plane of a finite element model, and the orientation is determined relative to a selected axis within that plane. Each crack is generated as elliptical cracks, with the length of the crack being the length of the major axis of the ellipse. Each of the computational modeling component 204, the training component 205, and the CNN 206 can be implemented as software instructions stored on a non-tangible computer readable medium and executed by an associated processor or implemented on dedicated hardware, such as an application specific integrated circuit or a field programmable gate array.

The computational modeling component 204 generates a virtual model of an article using computational modeling. In the illustrated implementation, the virtual model can be generated to represent an article with a crack with each of a length of a crack, defined as the longest dimension of the crack, an orientation of a crack, and the location of the crack manually or automatically selected for each virtual model. In the illustrated example, finite element simulations can be conducted utilizing a dynamic step timing that varies with the application, and in one example, a total time of eight microseconds is used with a step time size was fixed at two nanoseconds to match the frequency of a corresponding ultrasound imager. It will be appreciated that the material properties of each element will vary with the material from which the article is fabricated. For steel and other metals, linear elastic material properties can generally be used. For semi-crystalline polymers and other materials, viscoelastic behaviors may play a role in ultrasound transmission, and the linear, elastic assumption can be used only where appropriate. The inventors have determined, however, that where the acoustic traveling distance is not long and the frequency is not high (e.g., around 1 MHZ), the wave attenuation and dispersion have a negligible effect on the final ultrasound signals and the material response can be assumed dominantly elastic. The acceptable range for travelling distance and frequency will vary with the material, but for high-density polyethylene, the linear assumption holds for frequencies around one megahertz and a travelling distance of around twenty-five millimeters.

In the illustrated example, C3D8R elements that are one-tenth of a millimeter on each side size were used along a main ultrasound propagation path within the model. Any region containing a crack or other defect was meshed with finer C3D10M tetrahedral elements. The use of tetrahedron 3D10M elements around the defects in the illustrated example allows for a more accurate meshing ability near sharp crack tips and surfaces, while the C3D8R brick elements are computationally more efficient to use away from the defects. Further away from the defects, the mesh has C3D8R elements and gradually becomes coarser with a maximum size of eight-tenths of a millimeter at the outer boundaries in the 1 and 2 directions. This results in a total number of elements in each finite element simulation of between eight hundred thousand and one million.

The ultrasonic pulse was simulated using a time-dependent pressure boundary condition on a six-millimeter diameter circular region which replicated the size of the transducer element on the associated ultrasound scanner. A five megahertz, raised-cosine type waveform commonly generated by a piezoelectric element was simulated in the model. The amplitude, A, of this waveform can be described as:

$$A = \{ \begin{matrix}cos ( 2 π f t ) [ 1 - cos ( \frac{2 π f t}{m} ) ] & , 0 \leq t \leq \frac{m}{f} \\ 0 & , otherwise\end{matrix} \qquad Eq . 1$$

where t is the time, f is the pulse frequency, and m is the number of periods, with m=2 in the illustrated example in accordance with the ultrasonic transducer being simulated.

The ultrasonic signal receiver location is simulated to be in the same circular region, where the displacement history in the 3-direction of all nodes is collected. A simulated ultrasonic time signal is obtained by averaging the nodal displacements given as:

$$Signal ( t ) = \frac{1}{n} {Σ}_{i = 1}^{n} {u}_{3}^{i} ( t ) \qquad Eq . 2$$

where n is the number of nodes in the circular region.

In one example, a dataset with one thousand two-hundred simulated ultrasound signals is created for training. The simulated dataset is decomposed into two parts: nine hundred structured, regular grid data and three hundred augmented data. For the structured data, a range for crack length (one to five millimeters) and a range for the crack orientation (zero to ninety degrees) were each evenly divided into thirty intervals resulting in nine hundred samples. For computational efficiency in this example, the crack location is structured differently, with only three locations selected, and each of the nine hundred samples assigned one of these three location values in a random manner. Each of the augmented data samples were assigned randomly selected length, location, and orientation values within their individual ranges. In this example, the structured data served as the backbone for the input space, and the augmented data provided additional design points to improve training performance.

Ultrasound signals, both in the finite element simulation and in normally obtained ultrasound readings contain the waveform of the initial input pulse during the first microsecond. Since the focus is identification of crack characteristics from the reflected signal, the first 1.2 microseconds containing the initial pulse was removed from the eight-microsecond signal to improve and accelerate the training process. The resulting 6.8 microsecond signals were then normalized by taking the absolute value of each time sample in the signal and dividing it by the maximum amplitude in the signal. This is expressed as:

$$Signal ( t ) = \vert \frac{Signal ( t )}{max [ Signal ( t ) ]} \vert \qquad Eq . 3$$

The simulated ultrasound signal is paired with a parameter representing a defect or absence of a defect in the virtual sample and provided to a convolutional neural network (CNN) 206 as a training sample. In the illustrated implementation, the CNN 206 is implemented with two convolutional layers, a pooling layer, and two fully connected layers, although it will be appreciated the specific parameters and configuration of the CNN 206 can vary with the implementation. Each of the convolutional layers and the first connected layer uses a rectified linear unit activation function, and dropout is applied in the fully connected layers, with individual neurons randomly deactivated with a predetermine probability during training to avoid overfitting. In the example, each of the convolutional layers has a kernel size of eight, a stride of four, and a padding of two. The first convolutional layer has eight hundred fifty neurons in each of four channels, and the second convolutional layer has two hundred twelve neurons in each of eight channels. The pooling layer applies max pooling across the eight channels from the second convolutional layer with a kernel size of two and a stride of two, with one hundred six neurons in each of the eight channels. The first fully connected layer has four hundred neurons, and the second fully connected layer has three neurons, representing the length, location, and orientation of the crack. Adam is used as the optimization algorithm, with a mean squared error loss function. A dropout probability of 0.2 is used in the fully connected layer. The CNN 206 was trained with a learning rate of 0.001 and a maximum number of epochs of one thousand.

To demonstrate the effect of augmented data on training performance, a simulation-based error testing dataset was created with simulation results for randomly selected crack length, location, and orientation values. The CNN 206 was trained using the training dataset and evaluated on the testing dataset. It has been determined that, if only the structured data were used for training, the application of trained CNN 206 on testing data results in error slightly rising near one hundred fifty epochs. For the example system, the CNN 206 did not generalize to random design points when trained without a substantially large number of grid points for the location variable. In the example, this error in training can be resolved with the small set of augmented data rather than generating regular grids for all three parameters, which would require a very large set of training data.

FIG. 3 illustrates another example of a system 300 for training a machine learning model using a computer-generated virtual model. Interacting flaws refer to conditions when two flaws are in close proximity and have the potential to interact with each other to significantly reduce the integrity of a structure. Accurate detection and classification of non-visible interacting and single flaws using ultrasound time signals continue to be a significant challenge. Machine learning-based flaw detection and classification systems are promising, but have been unable to be implemented as they lack training data that are expected to be obtained from a large set of well-labeled field data or experiments. Cracks and corrosion wall loss are two flaw types of primary concern in metallic structures.

To this end, the system 300 utilizes simulations conducted at a computational modeling component 304 to generate signals representing ultrasound non-destructive testing A-scans and these signals are used at a training component 305 these to train a convolutional neural network (CNN) 306. In the illustrated implementation, the CNN 306 is trained to classify novel samples into five categories, representing an absence of a flaw, a single crack, single wall loss corrosion, two or more cracks, and a crack combined with corrosion. Each of the computational modeling component 304 and the CNN 306 can be implemented as software instructions stored on a non-tangible computer readable medium and executed by an associated processor.

The computational modeling component 304 generates a virtual model of an article using computational modeling. The virtual model can be generated to include one or more flaws, with various samples representing an article with no flaws, an article with one or more cracks, an article with corrosion, or an article having both cracks and corrosion. Multiple parameters are used to define the geometry for each category of flaw. Generally, for an elliptical crack, the geometry can be defined by its long axis, short axis, location, and orientation. It has been determined that, in practice, the long axis of a crack dominates the stress concentration and fracture behavior, and in some implementations, the short axis, or thickness of the crack, can be standardized to a selected value in generating training samples to streamline the training process. For a flaw representing partial spheroid wall loss corrosion, the flaw can be represented by its width, height, and location. In the illustrated example, the flaws were positioned in the center of the geometry except for samples including two flaws, in which case one crack is assigned both a horizontal offset and the vertical offset. The range of horizontal distance was selected to be twenty-five percent of the total thickness of the geometry, as the two flaws can be assumed to be interacting within this range.

The length of a crack, defined as the longest dimension of the crack, an orientation of a crack, and a location of the crack can be manually or automatically selected for each virtual model. In the illustrated implementation, the cracks are generated in the 1-3 plane of a finite element model, and the orientation is determined relative to a selected axis within that plane. In this example, finite element simulations can be conducted utilizing a dynamic step timing that varies with the application, and in one example, a total time of eight microseconds is used with a step time size was fixed at two nanoseconds to match the frequency of a corresponding ultrasound imager.

In the illustrated example, C3D8R elements that are one-tenth of a millimeter on each side size were used along a main ultrasound propagation path within the model. Any region containing a crack or other defect was meshed with finer C3D10M tetrahedral elements. The use of tetrahedron 3D10M elements around the defects in the illustrated example allows for a more accurate meshing ability near sharp crack tips and surfaces, while the C3D8R brick elements are computationally more efficient to use away from the defects. Further away from the defects, the mesh has C3D8R elements and gradually becomes coarser with a maximum size of eight-tenths of a millimeter at the outer boundaries in the 1 and 2 directions. This results in a total number of elements in each finite element simulation of between eight hundred thousand and one million. A linear elastic material response was assumed, with Young's modulus of one hundred eighty gigapascals, a Poisson ratio of 0.31, and a density of seven thousand three hundred kg/m³.

The ultrasonic pulse was simulated using a time-dependent pressure boundary condition on a six-millimeter diameter circular region which replicated the size of the transducer element on the associated ultrasound scanner. A five megahertz, raised-cosine type waveform commonly generated by a piezoelectric element was simulated in the model. The amplitude, A, of this waveform can be described as:

$$A = \{ \begin{matrix}cos ( 2 π f t ) [ 1 - cos ( \frac{2 π f t}{m} ) ] & , 0 \leq t \leq \frac{m}{f} \\ 0 & , otherwise\end{matrix} \qquad Eq . 4$$

where t is the time, f is the pulse frequency, and m is the number of periods, with m=2 in the illustrated example in accordance with the ultrasonic transducer being simulated.

The ultrasonic signal receiver location is simulated to be in the same circular region, where the displacement history in the 3-direction of all nodes is collected. A simulated ultrasonic time signal is obtained by averaging the nodal displacements given as:

$$Signal ( t ) = \frac{1}{n} {Σ}_{i = 1}^{n} {u}_{3}^{i} ( t ) \qquad Eq . 2$$

where n is the number of nodes in the circular region.

In one example, a dataset with two thousand five-hundred simulated ultrasound signals is created for training and testing, with five hundred simulated signals representing each output class. One hundred test samples are randomly selected from the five hundred samples available for each class, with the remaining four hundred used for training.

Ultrasound signals, both in the finite element simulation and in normally obtained ultrasound readings contain the waveform of the initial input pulse during the first microsecond. Since the focus is identification of crack characteristics from the reflected signal, the first 1.2 microseconds containing the initial pulse was removed from the eight-microsecond signal to improve and accelerate the training process. The resulting 6.8 microsecond signals were then normalized by taking the absolute value of each time sample in the signal and dividing it by the maximum amplitude in the signal. This is expressed as:

$$Signal ( t ) = \vert \frac{Signal ( t )}{max [ Signal ( t ) ]} \vert \qquad Eq . 6$$

The simulated ultrasound signal is paired with a parameter representing a defect or absence of a defect in the virtual sample and provided to a convolutional neural network (CNN) 306 as a training sample. In the illustrated implementation, the CNN 306 is implemented with two convolutional layers, a pooling layer, and two fully connected layers, although it will be appreciated the specific parameters and configuration of the CNN 306 can vary with the implementation. Each of the convolutional layers and the first connected layer uses a rectified linear unit activation function, and dropout is applied in the fully connected layers, with individual neurons randomly deactivated with a predetermined probability during training to avoid overfitting. In the example, the first convolutional layer has a kernel size of twenty, a stride of ten, and a padding of five. The second convolutional layer has a kernel size of eight, a stride of four, and no padding. The first convolutional layer has three hundred forty neurons in each of eight channels, and the second convolutional layer has eighty-four neurons in each of sixteen channels. The pooling layer applies max pooling across the sixteen channels from the second convolutional layer with a kernel size of two and a stride of two, with forty-two neurons in each of the sixteen channels. The first fully connected layer has three hundred neurons, and the second fully connected layer is a SoftMax layer with five neurons, representing the five output classes. Adam is used as the optimization algorithm, with a cross entropy loss function. A dropout probability of 0.2 is used in the first fully connected layer. The CNN 306 was trained with a learning rate of 0.001 and a maximum number of epochs of one thousand.

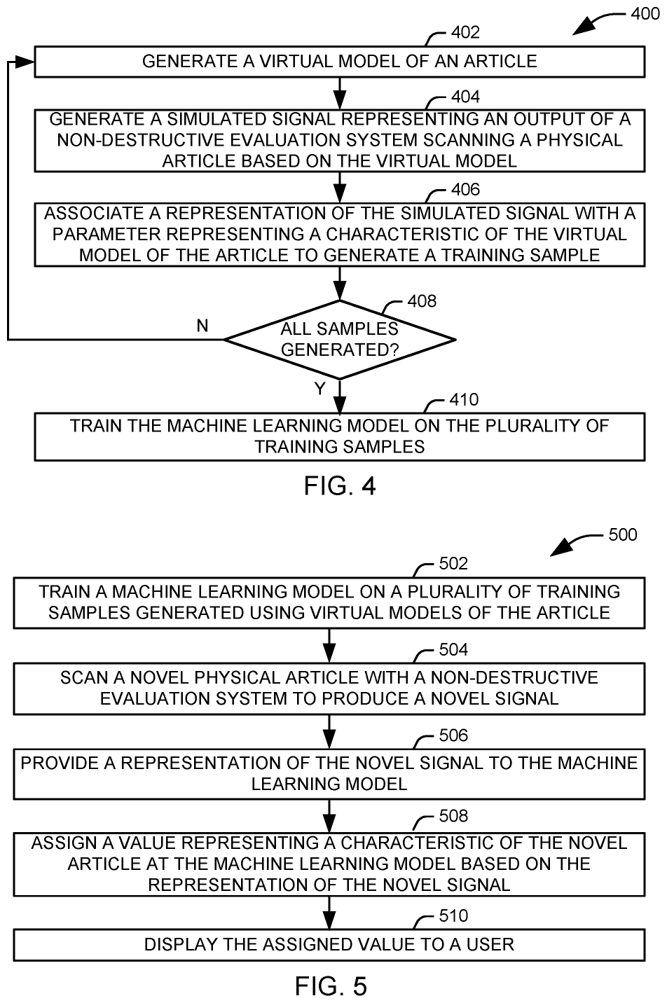

In view of the foregoing structural and functional features described above in FIGS. 1-3, example methods will be better appreciated with reference to FIGS. 4-6. While, for purposes of simplicity of explanation, the methods of FIGS. 4-6 are shown and described as executing serially, it is to be understood and appreciated that the present invention is not limited by the illustrated order, as some actions could in other examples occur in different orders and/or concurrently from that shown and described herein.

FIG. 4 illustrates an example of a method 400 for training a machine learning model for non-destructive evaluation. At 402, a virtual model of an article is generated in a computer system. In one example, the virtual model is generated using a finite element modeling system. It will be appreciated that the virtual model can be generated to have an internal or external defect within the article or no defect within the article, and parameters representing the geometry of any defect can be selected. For example, the defect can represent corrosion affecting the article or a crack within the article, and the parameters defining the geometry can represent a length, orientation, location, and thickness of a crack or the location, height, and width of a patch of corrosion. In one implementation, the parameters representing the geometry of any defects are randomly generated. In another implementation, the parameters representing any defects are preselected, for example, to provide values at regular intervals across a selected range of values for each parameter. In a further implementation, a first subset of virtual models used to generate training samples use preselected values for the geometries of any defects and a second subset of virtual models used to generate training samples use randomly selected values for the geometries of any defects.

At 404, a simulated signal representing an output of a non-destructive evaluation system scanning the article is generated at the computer system based on the virtual model. It will be appreciated that the simulated signal can represent a time series of returns that would be expected for a scan of a physical article modeled by the virtual article at the non-destructive evaluation system. The simulated signal can be normalized to a standard scale of values, for example, by dividing each value in the time series by a maximum value across the time series. In one example, the simulated signal is a simulated ultrasound signal representing an output of an ultrasound system scanning the article based on the virtual model at the computer system.

At 406, a representation of the simulated signal is associated with a parameter representing a characteristic of the virtual model of the article to generate the given training sample. The representation of the simulated signal can be a set of numerical features representing the signal or the signal itself, with or without preprocessing, such as normalization. For example, where the machine learning model is a convolutional neural network, the simulated signal itself, with or without normalization, can be used as the input. In one example, the parameter is a categorical parameter representing the presence or absence of a defect or a specific type of defect. In another example, the parameter is a continuous parameter representing the geometry of a defect, such as a physical dimension, location, or orientation of the defect. At 408, it is determined if a desired number of training samples has been generated. If not (N), the method returns to 402 to generate another training sample. If all desired training samples have been generated (Y), the method advances to 410, where the machine learning model is trained on the plurality of training samples.

FIG. 5 illustrates a method 500 for non-destructive testing of a physical article. At 502, a machine learning model is trained on a plurality of training samples generated using virtual models of examples of the physical article, with at least a subset of the training samples being generated using virtual models having a defect with known characteristics. For example, the machine learning model can be trained using the method described in FIG. 4. At 504, a novel physical article is scanned with a non-destructive evaluation system to produce a novel signal. At 506, a representation of the novel signal is provided to the machine learning model. At 508, a value representing a characteristic of the novel article is assigned at the machine learning model based on the representation of the novel signal. For example, the value can represent the presence of absence of a defect generally or of a specific type of defect or a geometry of a defect in the article. At 510, the assigned value is displayed to a user at an associated display.

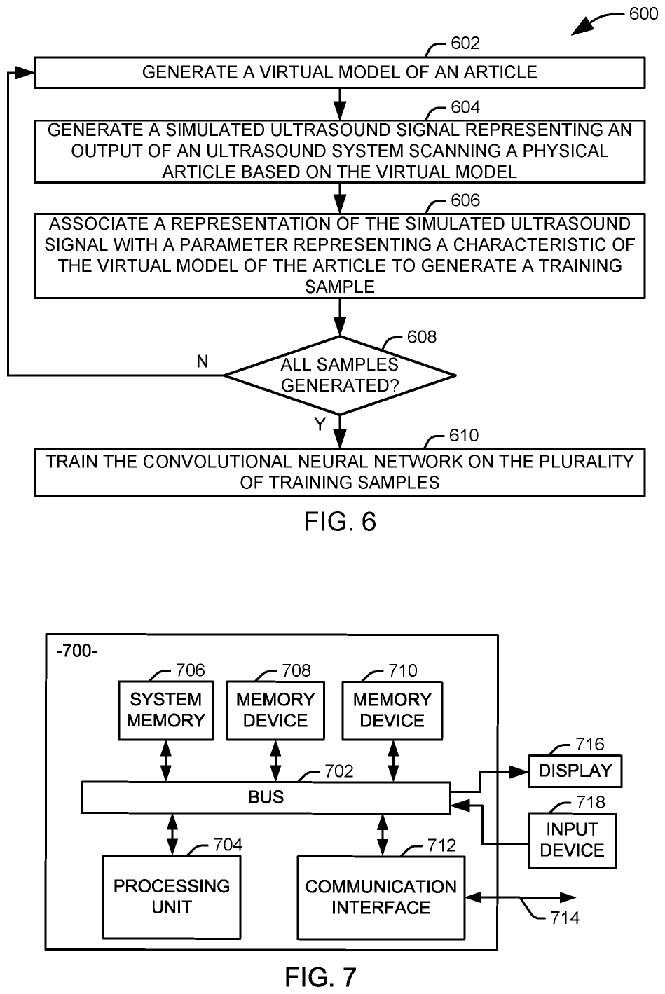

FIG. 6 illustrates another example of a method 600 for training a convolutional neural network for non-destructive evaluation. At 602, a virtual model of an article is generated at a computer system. In one example, the virtual model is generated using a finite element modeling system. It will be appreciated that the virtual model can be generated to have an internal or external defect within the article or no defect within the article, and parameters representing a geometry of any defect can be selected. For example, the defect can represent corrosion affecting the article or a crack within the article, and the parameters defining the geometry can represent a length, orientation, location, and thickness of a crack or the location, height, and width of a patch of corrosion. In one implementation, the parameters representing the geometry of any defects are randomly generated. In another implementation, the parameters representing any defects are preselected, for example, to provide values at regular intervals across a selected range of values for each parameter. In a further implementation, a first subset of virtual models used to generate training samples use preselected values for the geometries of any defects and a second subset of virtual models used to generate training samples use randomly selected values for the geometries of any defects.

At 604, a simulated signal representing an output of an ultrasound system scanning the article is generated at the computer system based on the virtual model. It will be appreciated that the simulated ultrasound signal can represent a time series of returns that would be expected for a scan of a physical article modeled by the virtual article at the ultrasound system. The method can instead or additionally use parameters representing the frequency content of signal. The simulated ultrasound signal can be normalized to a standard scale of values, for example, by dividing each value in the time series by a maximum value across the time series. At 606, the simulated ultrasound signal is associated with a parameter representing a characteristic of the virtual model of the article to generate the given training sample. The simulated signal can be subjected to preprocessing, such as normalization, to provide a more consistent values within the set of training samples. In one example, the parameter is a categorical parameter representing the presence or absence of a defect or a specific type of defect. In another example, the parameter is a continuous parameter representing the geometry of a defect, such as a physical dimension, location, or orientation of the defect. In one implementation, the parameter represents one of a plurality of classes, the plurality of classes including a first class representing an absence of a defect in the virtual model of the article, a second class representing the presence of a first type of defect in the virtual model of the article, a third class representing a second type of defect in the virtual model of the article, and a fourth class representing multiple defects in the virtual model of the article.

At 608, it is determined if a desired number of training samples has been generated. If not (N), the method returns to 602 to generate another training sample. If all desired training samples have been generated (Y), the method advances to 610, where the convolutional neural network is trained on the plurality of training samples. It will be appreciated that, while the convolutional neural network may be trained at a computer system, once the parameters for the model, such as link weights between layers of the model, are known, the convolutional neural network itself can be implemented as software executed by an associated processor, as dedicated hardware, or as a mix of software and dedicated hardware. In one example, the convolutional neural network is implemented on an integrated circuit chip onboard a non-destructive evaluation system.

FIG. 7 is a schematic block diagram illustrating an exemplary system 700 of hardware components capable of implementing examples of the systems and methods disclosed in FIGS. 1-6, such as system 100 for training a machine learning model for use in non-destructive testing of physical articles illustrated in FIG. 1. The system 700 can include various systems and subsystems. The system 700 can be a personal computer, a laptop computer, a workstation, a computer system, an appliance, an application-specific integrated circuit (ASIC), a server, a server blade center, a server farm, etc.

The system 700 can include a system bus 702, a processing unit 704, a system memory 706, memory devices 708 and 710, a communication interface 712 (e.g., a network interface), a communication link 714, a display 716 (e.g., a video screen), and an input device 718 (e.g., a keyboard and/or a mouse). The system bus 702 can be in communication with the processing unit 704 and the system memory 706. The additional memory devices 708 and 710, such as a hard disk drive, server, stand-alone database, or other non-volatile memory, can also be in communication with the system bus 702. The system bus 702 interconnects the processing unit 704, the memory devices 706-710, the communication interface 712, the display 716, and the input device 718. In some examples, the system bus 702 also interconnects an additional port (not shown), such as a universal serial bus (USB) port.

The processing unit 704 can be a computing device and can include an application-specific integrated circuit (ASIC). The processing unit 704 executes a set of instructions to implement the operations of examples disclosed herein. The processing unit can include a processing core.

The additional memory devices 706, 708, and 710 can store data, programs, instructions, database queries in text or compiled form, and any other information that can be needed to operate a computer. The memories 706, 708 and 710 can be implemented as computer-readable media (integrated or removable) such as a memory card, disk drive, compact disk (CD), or server accessible over a network. In certain examples, the memories 706, 708 and 710 can comprise text, images, video, and/or audio, portions of which can be available in formats comprehensible to human beings. Additionally or alternatively, the system 700 can access an external data source or query source through the communication interface 712, which can communicate with the system bus 702 and the communication link 714.

In operation, the system 700 can be used to implement one or more parts of a system for training machine learning models for use in non-destructive testing in accordance with the present invention. Computer executable logic for implementing the evaluation system resides on one or more of the system memory 706, and the memory devices 708 and 710 in accordance with certain examples. The processing unit 704 executes one or more computer executable instructions originating from the system memory 706 and the memory devices 708 and 710. The term “computer readable medium” as used herein refers to any medium that participates in providing instructions to the processing unit 704 for execution, and it will be appreciated that a computer readable medium can include multiple computer readable media each operatively connected to the processing unit.

Also, it is noted that the embodiments can be described as a process which is depicted as a flowchart, a flow diagram, a data flow diagram, a structure diagram, or a block diagram. Although a flowchart can describe the operations as a sequential process, many of the operations can be performed in parallel or concurrently. In addition, the order of the operations can be re-arranged. A process is terminated when its operations are completed, but could have additional steps not included in the figure. A process can correspond to a method, a function, a procedure, a subroutine, a subprogram, etc. When a process corresponds to a function, its termination corresponds to a return of the function to the calling function or the main function.

Furthermore, embodiments can be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks can be stored in a machine-readable medium such as a storage medium. A code segment or machine-executable instruction can represent a procedure, a function, a subprogram, a program, a routine, a subroutine, a module, a software package, a script, a class, or any combination of instructions, data structures, and/or program statements. A code segment can be coupled to another code segment or a hardware circuit by passing and/or receiving information, data, arguments, parameters, and/or memory contents. Information, arguments, parameters, data, etc., can be passed, forwarded, or transmitted via any suitable means, including memory sharing, message passing, ticket passing, network transmission, etc.

For a firmware and/or software implementation, the methodologies can be implemented with modules (e.g., procedures, functions, and so on) that perform the functions described herein. Any machine-readable medium tangibly embodying instructions can be used in implementing the methodologies described herein. For example, software codes can be stored in a memory. Memory can be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” can represent one or more memories for storing data, including read only memory (ROM), random access memory (RAM), magnetic RAM, core memory, magnetic disk storage mediums, optical storage mediums, flash memory devices and/or other machine-readable mediums for storing information. The term “machine-readable medium” includes, but is not limited to portable or fixed storage devices, optical storage devices, wireless channels, and/or various other storage mediums capable of storing that contain or carry instruction(s) and/or data.

What have been described above are examples of the present invention. It is, of course, not possible to describe every conceivable combination of components or methodologies for purposes of describing the present invention, but one of ordinary skill in the art will recognize that many further combinations and permutations of the present invention are possible. While certain novel features of this invention shown and described below are pointed out in the annexed claims, the invention is not intended to be limited to the details specified, since a person of ordinary skill in the relevant art will understand that various omissions, modifications, substitutions and changes in the forms and details of the invention illustrated and in its operation may be made without departing in any way from the spirit of the present invention. Accordingly, the present invention is intended to embrace all such alterations, modifications, and variations that fall within the scope of the appended claims. As used herein, the term “includes” means includes but not limited to, the term “including” means including but not limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements. No feature of the invention is critical or essential unless it is expressly stated as being “critical” or “essential.”

What is claimed is:

1. A method for training a machine learning model for non-destructive evaluation, the method comprising:
generating a plurality of training samples, wherein each of a subset of the plurality of training samples represents an article with a defect and generating a given training sample comprises:
generating a virtual model of the article on a computer system;
generating a simulated signal representing an output of a non-destructive evaluation system scanning the article based on the virtual model at the computer system; and
associating a representation of the simulated signal with a parameter representing a characteristic of the virtual model of the article to generate the given training sample; and
training the machine learning model on the plurality of training samples.

2. The method of claim 1, wherein generating a virtual model of the article at a computer system represents generating a virtual model of an article having an internal defect, and the parameter represents geometrical characteristics of the internal defect.

3. The method of claim 1, further comprising:
scanning a physical article with a non-destructive evaluation system to produce a signal;
providing a representation of the signal to the machine learning model;
assigning a value representing the characteristic to the physical article at the machine learning model based on the representation of the signal; and
displaying the assigned defect feature value to a user at an associated display.

4. The method of claim 1, wherein a defect associated with a first training sample of the plurality of training samples represents corrosion affecting the article associated with the first training sample.

5. The method of claim 1, wherein a defect associated with a first training sample of the plurality of training samples represents a crack within the article associated with the first training sample.

6. The method of claim 1, wherein generating the simulated signal representing the output of the non-destructive evaluation system scanning the article based on the virtual model comprises generating a simulated ultrasound signal representing an output of an ultrasound system scanning the article based on the virtual model at the computer system.

7. The method of claim 1, wherein the machine learning model is a convolutional neural network and associating the representation of the simulated signal with the characteristic to generate the given training sample comprises associating the simulated signal with the characteristic to generate the given training sample.

8. The method of claim 1, wherein the characteristic is a first characteristic of a plurality of characteristics, and the parameter is a first parameter of a plurality of parameters corresponding to the plurality of characteristics, wherein a first proper subset of the plurality of training samples is assigned predetermined values for the plurality of parameters associated with each training sample of the first proper subset, and a second proper subset of the plurality of training samples is assigned random values for the plurality of parameters associated with each training sample of the second proper subset.

9. A system comprising:
a processor; and
a non-transitory computer readable medium storing instructions for training a machine learning model for non-destructive testing, the instructions being executable by the processor to provide:
a sample generation system that generates a plurality of training samples, wherein each of a subset of the plurality of training samples represents an article with a defect, the sample generation system comprising:
a computational modeling component that generates a virtual model of a given article and generates a simulated signal representing an output of a non-destructive evaluation system scanning the article based on the virtual model; and
a sample labeler that associates a representation of the simulated signal with a parameter representing a characteristic of the virtual model of the given article to generate the given training sample; and
a training component that trains the machine learning model on the plurality of training samples to produce a trained machine learning model.

10. The system of claim 9, wherein the computational modeling component is implemented as a finite element modeling system.

11. The system of claim 9, wherein the trained machine learning model is implemented as an integrated circuit chip onboard a non-destructive evaluation system.

12. The system of claim 9, wherein the computational modeling system generates a simulated ultrasound signal representing an output of an ultrasound system scanning the article as a time series of values.

13. The system of claim 9, wherein the machine learning model is a convolutional neural network having a plurality of convolutional layers, a pooling layer, and a plurality of fully connected layers, the training component providing a set of sample values representing the simulated signal directly to a first convolutional layer of the plurality of convolutional layers.

14. The system of claim 9, wherein the parameter represents one of a plurality of classes, the plurality of classes including a first class representing an absence of a defect in the virtual model of the article, a second class representing the presence of a first type of defect in the virtual model of the article, a third class representing a second type of defect in the virtual model of the article, and a fourth class representing multiple defects in the virtual model of the article.

15. The system of claim 9, wherein the parameter represents one of a length of a crack in the virtual model of the article, an orientation of the crack in the virtual model of the article, and a location of the crack in the virtual model of the article.

16. A method for training a convolutional neural network for non-destructive evaluation, the method comprising:
generating a plurality of training samples, having selected characteristics, in an article, wherein each of a subset of the plurality of training samples represents an article with a defect and generating a given training sample comprises;
generating a virtual model of the article at a computer system;
generating a simulated ultrasound signal representing an output of an ultrasound imager scanning the article based on the virtual model at the computer system; and
associating the simulated ultrasound signal with a parameter representing at least one of the selected characteristics to generate the given training sample; and
training the convolutional neural network on the plurality of training samples to provide a trained convolutional neural network.

17. The method of claim 16, wherein the trained convolutional neural network is implemented on an integrated circuit chip onboard a non-destructive evaluation system.

18. The method of claim 16, wherein the parameter represents one of a plurality of classes, the plurality of classes including a first class representing an absence of a defect in the virtual model of the article, a second class representing the presence of a first type of defect in the virtual model of the article, a third class representing a second type of defect in the virtual model of the article, and a fourth class representing multiple defects in the virtual model of the article.

19. The method of claim 16, wherein the parameter represents one of a length of a crack in the virtual model of the article, an orientation of the crack in the virtual model of the article, and a location of the crack in the virtual model of the article.

20. The method of claim 16, wherein the parameter represents one of a length of a patch of corrosion in the virtual model of the article, a width of the patch of corrosion in the virtual model of the article, and a location of the patch of corrosion in the virtual model of the article.
